(19) United States
(12) Patent Application Publication
(10) Pub. No.: US 2015/0090380 A1
(43) Pub. Date: Apr. 2, 2015

(54) Air Power Feature For A Tire Or Wheel

(71) Applicant: Bridgestone Americas Tire Operations, LLC, Nashville, TN (US)

(72) Inventors: Brian D. Steenwyk, Uniontown, OH (US); Stephen M. Vossberg, Uniontown, OH (US); Stephen J. Presutti, Cuyahoga Falls, OH (US)

(21) Appl. No.: 14/388,003

(22) PCT Filed: Mar. 20, 2013
(86) PCT No.: PCT/US13/33112

§ 371 Date: Sep. 25, 2014

Related U.S. Application Data
(60) Provisional application No. 61/615,921, filed on Mar. 27, 2012.

(51) Int. Cl. B60C 23/12; H02K 7/18; B60C 19/00

(52) U.S. Cl. CPC B60C 23/12; B60C 19/00; H02K 7/18
USPC 152/152.1; 290/52

(57) ABSTRACT

Provided is an apparatus comprising an air power feature engaged with a tire or an air power feature engaged with a wheel.

### TECHNICAL FIELD

The present subject matter relates generally to a tire or wheel. More, specifically, the present subject matter relates to an air power feature in engagement with tire or wheel or a tire-wheel system.

### BACKGROUND

Tires may be equipped with a tire pressure monitoring system or other equipment. Some kinds of equipment with which a tire may be equipped may use electrical energy.

It remains desirable to develop technology to supply electrical energy to equipment with which a tire may be equipped.

### SUMMARY

Provided is an apparatus comprising an air power feature engaged with a tire or an air power feature engaged with a wheel.

Further provided is a tire-wheel system comprising a wheel, a tire mounted to the wheel, and an air power feature.

Further provided is a pneumatic tire comprising a tread surface, a first sidewall surface, an annular interior surface opposite the tread surface, a first sidewall internal surface opposite the first sidewall surface, and an air power feature. The air power feature may be engaged with the annular interior surface or the first sidewall internal surface by an adhesive, or by a mechanical fastener, or by a molding operation, or by a component integrally formed therewith. The air power feature may be engaged with an air flow modification component comprising a duct of constant cross-sectional area, or a converging nozzle, or a diverging nozzle, or a converging-diverging nozzle, or a screen, or a filter, or some combination thereof. The air power feature may comprise either a turbine and a generator, or a piezoelectrical air power feature.

### BRIEF DESCRIPTION OF THE DRAWINGS

FIG. 1 is a side view of one embodiment of a tire model showing computational fluid dynamics results.

FIG. 2 is a front view of the crown region of one embodiment of a tire showing computational fluid dynamics results.

FIG. 3 is a front view of the footprint region of one embodiment of a tire showing computational fluid dynamics results.

FIG. 4 is a front sectional view of one embodiment of a tire-wheel system.

FIG. 5 is a graph showing velocity at the bottom of a tire on the vertical axis and radial distance on the horizontal axis.

FIG. 6 is a graph showing velocity at the bottom of a tire relative to straight translation with the tire on the vertical axis and radial distance on the horizontal axis.

FIG. 7 is a graph showing velocity at the bottom of a tire relative to rigid rotation with the wheel on the vertical axis and radial distance on the horizontal axis.

FIG. 8 is a graph showing velocity at the top of a tire on the vertical axis and radial distance on the horizontal axis.

FIG. 9 is a graph showing velocity at the top of a tire relative to rigid rotation with the tire on the vertical axis and radial distance on the horizontal axis.

FIG. 10 is a graph showing velocity at the top of a tire relative to rigid rotation with a wheel on the vertical axis and radial distance on the horizontal axis.

FIG. 11 is a schematic side view of one embodiment of a tire showing air cavity flow velocity profiles at the crown region and at the footprint region.

FIG. 12 is top sectional view of one embodiment of an air power feature engaged with the footprint region of an associated tire.

FIG. 13 is top sectional view of another embodiment of an air power feature.

FIG. 14 is side sectional view of another embodiment of an air power feature.

FIG. 15 is side sectional view of another embodiment of an air power feature.

FIG. 16 is side sectional view of another embodiment of an air power feature.

FIG. 17 is side sectional view of another embodiment of an air power feature.

FIG. 18 is a front sectional view of another embodiment of an air power feature showing a transmission engaged therewith.

### DETAILED DESCRIPTION

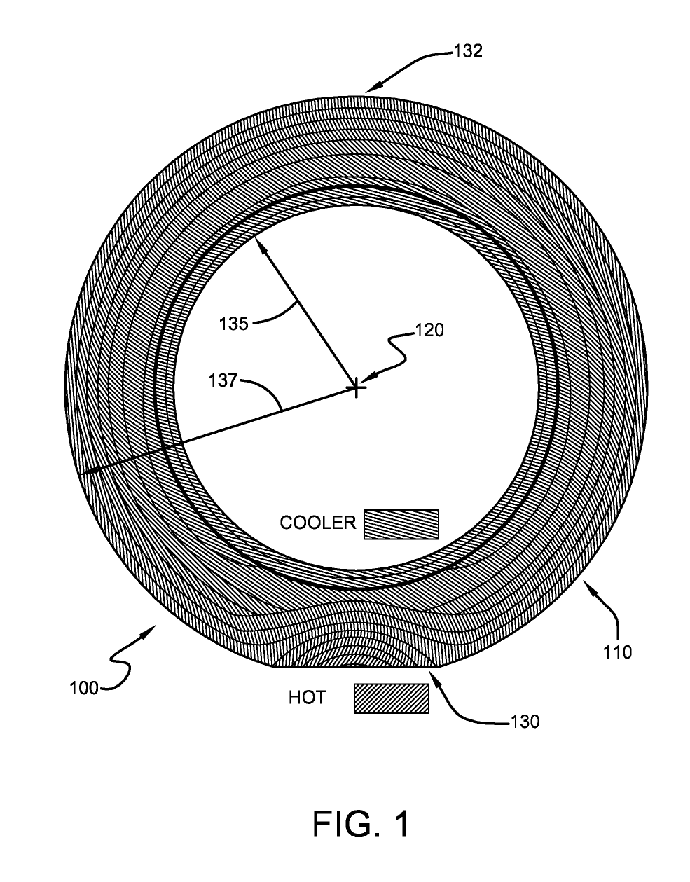

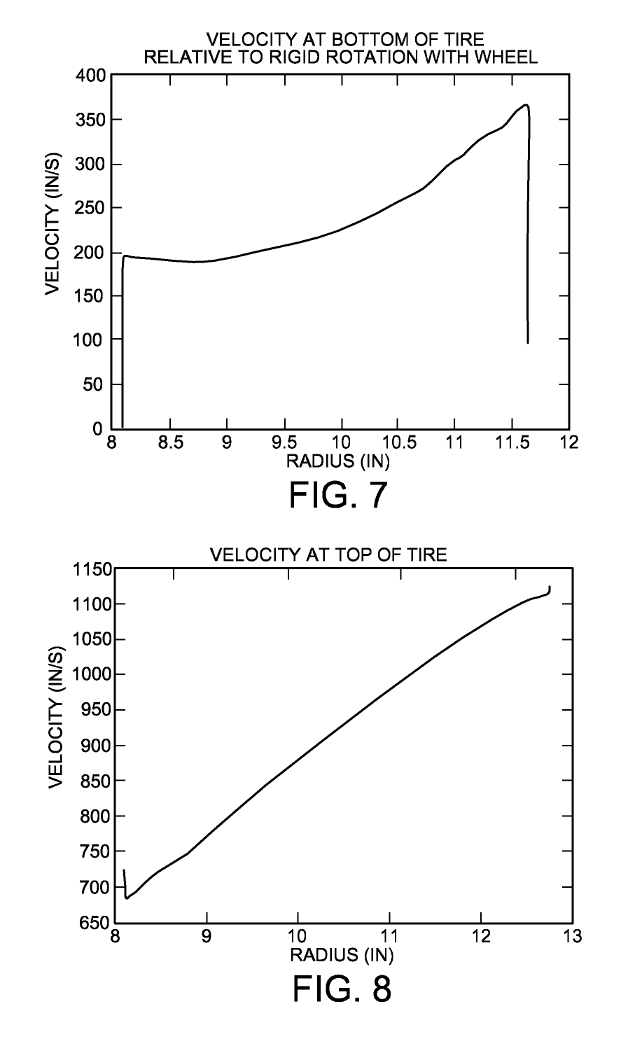

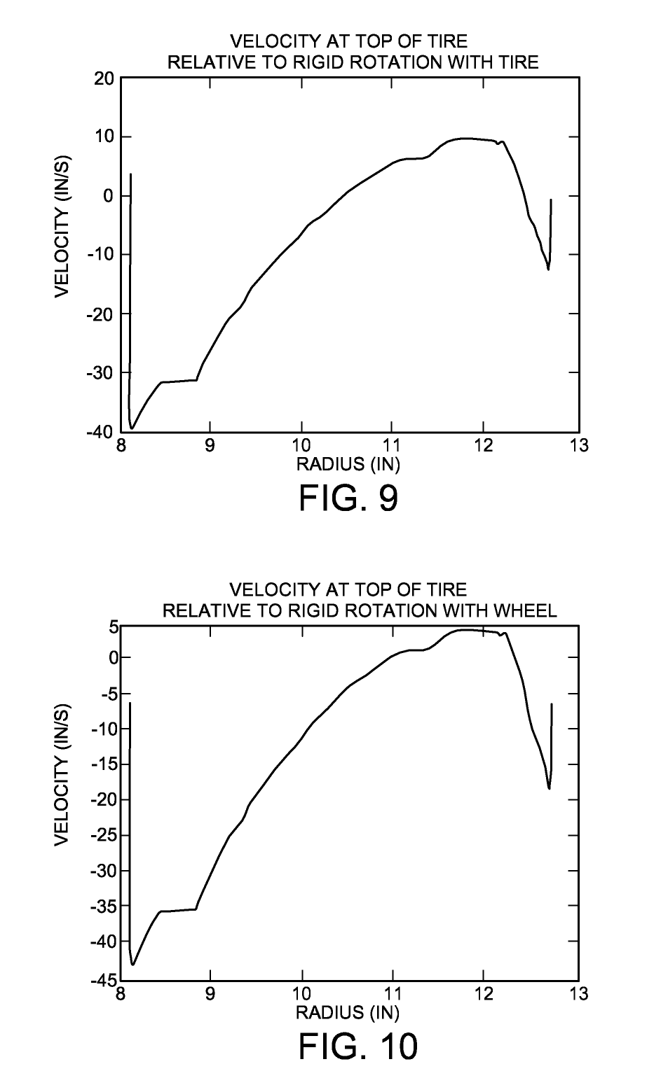

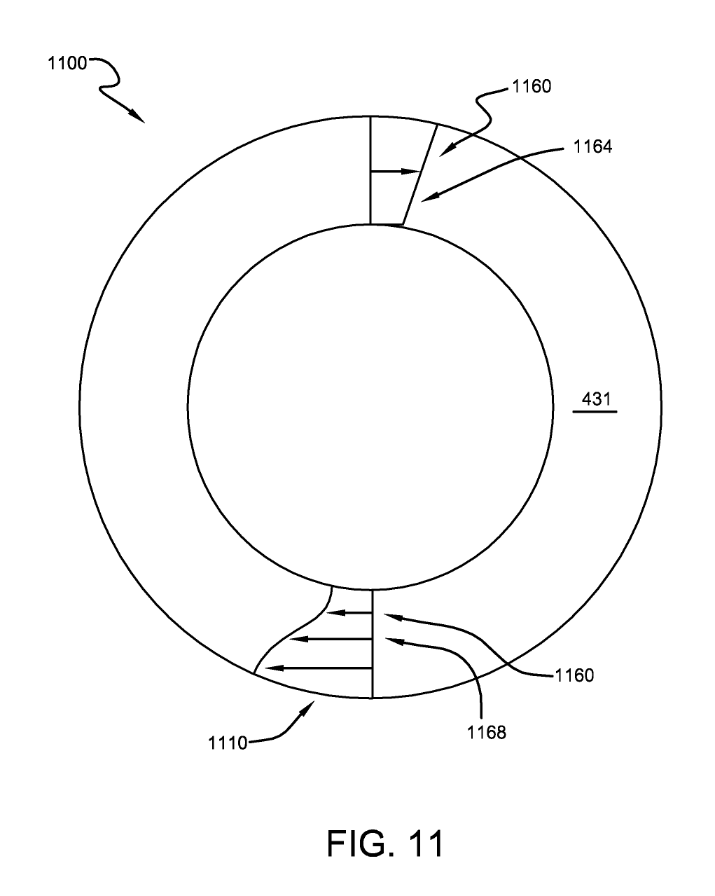

Reference will be made to the drawings, FIGS. 1-18, wherein the showings are only for purposes of illustrating certain embodiments of an air power feature, a tire comprising an air power feature, a wheel comprising an air power feature, and a tire-wheel system comprising an air power feature.

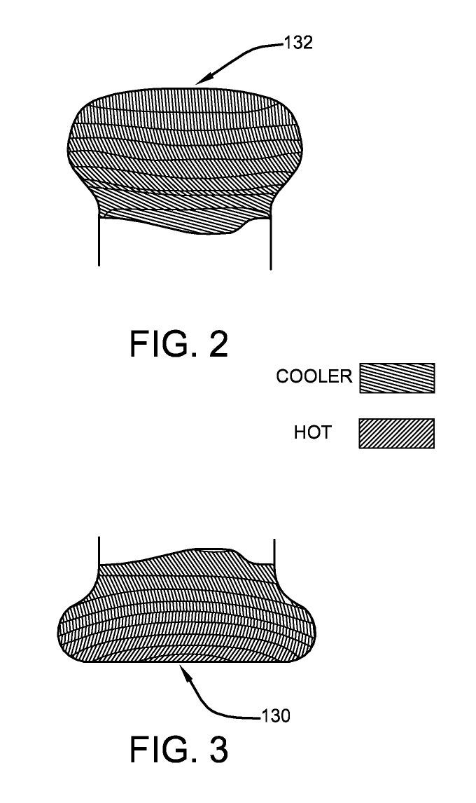

FIG. 1 shows a side view of one embodiment of a tire model 100 showing graphic computational fluid dynamics results 110. FIGS. 2 and 3 show these same computational fluid dynamics results 110 from frontal viewpoints proximate to the crown 132, and proximate to the footprint region 130, respectively. The computational fluid dynamics results 110 show velocity of an air flow 1160 of the inflation air 431 throughout the tire model 100. As used herein unless otherwise noted, air is used in the general sense to refer to a gas used for inflation of a pneumatic tire and is not limited to atmospheric air, or shop air, or dry air, but rather may comprise other gases; air may comprise atmospheric air, shop air, dry air, nitrogen, argon, other gases, or mixtures thereof. Similarly, air flow 1160 may refer to flow of any of the gases that air may comprise. Referring again to FIGS. 1-3, the computational fluid dynamics results 110 are based on assumptions of a P215/55R17 passenger size tire rolling along a roadway, in this case a 10 foot diameter drum, at 65 mph under a 1146 lbf load and inflated with shop air as inflation air 431 to 30.5 psi cold and 33.4 psi hot. While the specific results shown in FIGS. 1-3 may depend on the above inputs, the general trends and findings herein are not specific to any particular tire, tire size, speed, load, inflation gas, roadway or inflation pressure. In FIGS. 1-3, the calculated flow velocity at any given point based on the above assumptions, is primarily a function of two variables: 1) radial distance from the axis of rotation 120 of the tire model 100; 2) proximity to the footprint region 130. Addressing the flow velocity as a function of radial distance from the axis of rotation 120 of the tire model 100 first, in general, flow closer to the axis of rotation 120 of the tire model 100 is slower than the flow further from the axis of rotation 120. In regions distal from the footprint region 130, the flow along inner radius 135, is approximately 715 inches per second. In regions distal from the footprint region 130, the flow along outer radius 137, is approximately 1142 inches per second. In general, in regions distal from the footprint region 130, the flow velocity can be substantially described as a positive function of radial position. Addressing the flow velocity as a function of proximity to the footprint region 130, in the region proximate to the footprint region 130 the flow at any given radial position is substantially faster than flow at the same radial position in regions distal from the footprint region 130. The reasons for this will be addressed more fully herebelow. In general, in regions proximate to the footprint region 130, the flow velocity can be substantially fully described as a positive function of radial position and proximity to the center of the footprint.

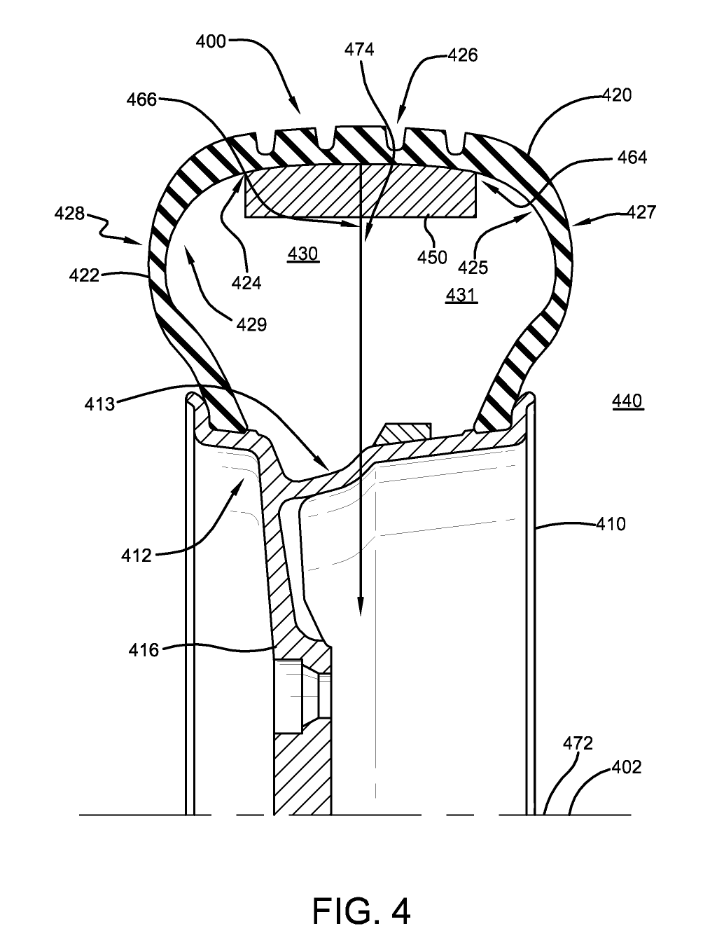

The tire model 100 shown in FIGS. 1-3 may represent the performance of air in a tire-wheel system 400 during operation thereof. The tire wheel system 400 comprises a wheel 410 and a tire 420. As a tire-wheel system 400 operates, it rotates. In the non-limiting embodiment shown in FIG. 4, tire 420 is a pneumatic tire 422. In other embodiments, tire 400 may be a run flat tire or another sort of tire. A pneumatic tire 422 is a tire 420 that is adapted for inflation with inflation air 431. As the tire-wheel system 400 rotates during operation, the inflation air 431 will tend to rotate within the pneumatic tire 422 such that it will tend to form an air flow 1160. Wheel 410 may comprise any of various kinds wheels adapted to have a tire 420 mounted thereabout. In the embodiments shown in FIG. 4, wheel 410 comprises a rim portion 412 adapted for engagement with tire 420, such as, without limitation, pneumatic tire 422, and a plate portion 416 adapted for engagement with an associated vehicle (not shown). Unless otherwise noted, engagement refers to components that are engaged either directly or indirectly. Components that are in direct engagement are in direct contact with one another. Components that are in indirect engagement are separated by one or more intermediate components. The rim portion 412 comprises an annular exterior surface, 413 extending around axis 402 in a closed loop and therefore has a wheel circumference that defines a wheel circumferential direction. While the rim portion 412 is shown varying in radius from axis 402 such that the wheel circumference varies with axial position, the circumferential direction taken at any given axial position is the same as that at any other axial position. In the embodiment shown in FIG. 4, the tire 420 and the wheel 410 together define an internal cavity 430. An internal cavity 430 may be defined by a set of surfaces comprising surfaces comprised by tire 420 and surfaces comprised by wheel 410. Internal cavity 430 is defined by a set of surfaces comprised by tire 420 comprising an annular interior surface 424 opposite the tread surface 426, and a first sidewall internal surface 425 opposite first sidewall surface 427, and by a set of surfaces comprised by wheel 410, wheel rim surface 413. The internal cavity 430 is substantially isolated from the surrounding environment 440 by the tire 420 and the wheel 410 and may contain air or be inflated with inflation air 431 to some pressure above that of the surrounding environment 440. In the embodiment shown in FIG. 4, pneumatic vehicle tire 422 comprises an axis of operational rotation 402 that defines and coincides with tire axial direction 472. Pneumatic vehicle tire 422 comprises an annular interior surface 424 that extends around axis 472 in a closed loop and therefore has a circumference that defines a tire circumferential direction. Pneumatic vehicle tire 422 further comprises a tire radial direction 474 that is mutually perpendicular to both the tire axial direction 472 and the tire circumferential direction. The annular interior surface 424 loops around the tire fully and therefore has a circumference, defines an interior surface circumferential direction 1202 along the annular interior surface in the direction of the circumference, defines an interior surface meridinal direction 464 tangent to the annular interior surface 424 and perpendicular to the interior surface circumferential direction 1202, and defines an interior surface normal direction 466 mutually perpendicular both to the interior surface circumferential direction 1202 and to the interior surface meridinal direction 464. The annular interior surface 424 may be adapted for engagement to a wheel 410. The annular interior surface 424 may be engaged with wheel rim surface 413 indirectly by first sidewall surface 427 and by second tire sidewall 428.

The tire circumferential direction 1204 coincides with interior surface circumferential direction 1202. In order to avoid repetition, unless otherwise noted herein, references to the interior surface circumferential direction 1202 also apply to the tire circumferential direction 1204. Similarly, the tire radial direction 474 coincides with interior surface normal direction 466. In order to avoid repetition, unless otherwise noted herein, references to the interior surface normal direction 466 also apply to the tire radial direction 474. In general, the interior surface meridinal direction 464 does not necessarily coincide with the tire axial direction 472 because the former is defined in part by the tangent to the annular interior surface 424, which may be curved, and the latter is defined by the axis of operational rotation 402, which is straight. It should be noted that in regions where the annular interior surface 424 is planar and parallel to the axis of operational rotation 402, such as may occur when the annular interior surface 424 passes through the tire footprint, the interior surface meridinal direction 464 may coincide with the tire axial direction 472.

The above-described directions may be used to define two different coordinate systems each usable for describing other directions. A first coordinate system may be defined comprising the mutually independent directions of the interior surface circumferential direction 1202, the interior surface normal direction 466, and the interior surface meridinal direction 464. A second coordinate system may be defined comprising the mutually independent directions of the tire circumferential direction 1204, the tire radial direction 474, and the tire axial direction 472. Using either the first coordinate system or the second coordinate system, an arbitrary direction may be defined therein in terms of vector sums of the vectors defined along the coordinate axes. Since the magnitude of an arbitrary direction is irrelevant, the magnitude of the vectors defined along the coordinate axes are also irrelevant and all may be assumed to be unitary without loss of generality.

In operation, tire-wheel system 400 will rotate and thereby roll or slide along a roadway (not shown). Also, during operation it is common for a tire-wheel system 400 to operate under some kind of load. The load may be a vehicle load, such as, some fraction of the weight of a vehicle, or it may be some other load, including but not limited to, a cargo load, a dynamic load, or the weight of tire-wheel system 400. A load will result in deformation of the tire region contacting the roadway into a tire footprint 1110 as shown in FIG. 11. During operation, the individual elements comprising tire wheel system 400 will undergo rotation at a common rate such that any given element will have substantially the same angular velocity as every other element.

Inflation air 431 of a rotating pneumatic tire-wheel system 400 will tend to rotate along with a neighboring mass 431, 425, 424, 413. A neighboring mass 431, 425, 424, 413 may comprise annular interior surface 424, wheel rim surface 413, sidewall internal surface 425, or another quantity or fraction of the inflation air 431. In pneumatic tire-wheel system 400, the internal cavity 430 is bounded radially by annular interior surface 424, defining an outer radial limit, and wheel rim surface 413, defining a smaller inner radial limit. As noted above, during operation the annular interior surface 424 and the wheel rim surface 413 will rotate at substantially the same angular velocity. Since the annular interior surface 424 and the wheel rim surface 413 will rotate at substantially the same angular velocity but differ in their distance from the axis of rotation 402, the velocity at which they are moving differ from one another with the annular interior surface 424 being the faster. As noted above, the portion of the inflation air 431 closest to the annular interior surface 424 will tend to move at a rate along with the annular interior surface 424, while the portion of the inflation air 431 closest to the wheel rim surface 413 will tend to move at a rate along with the wheel rim surface 413, so that the portion of the inflation air 431 closest to the annular interior surface 424 will tend to move faster than the portion of the inflation air 431 closest to the wheel rim surface 413. This trend is generally borne out by the computational fluid dynamics results 110 shown in FIGS. 1-3. This trend is shown graphically in FIG. 8.

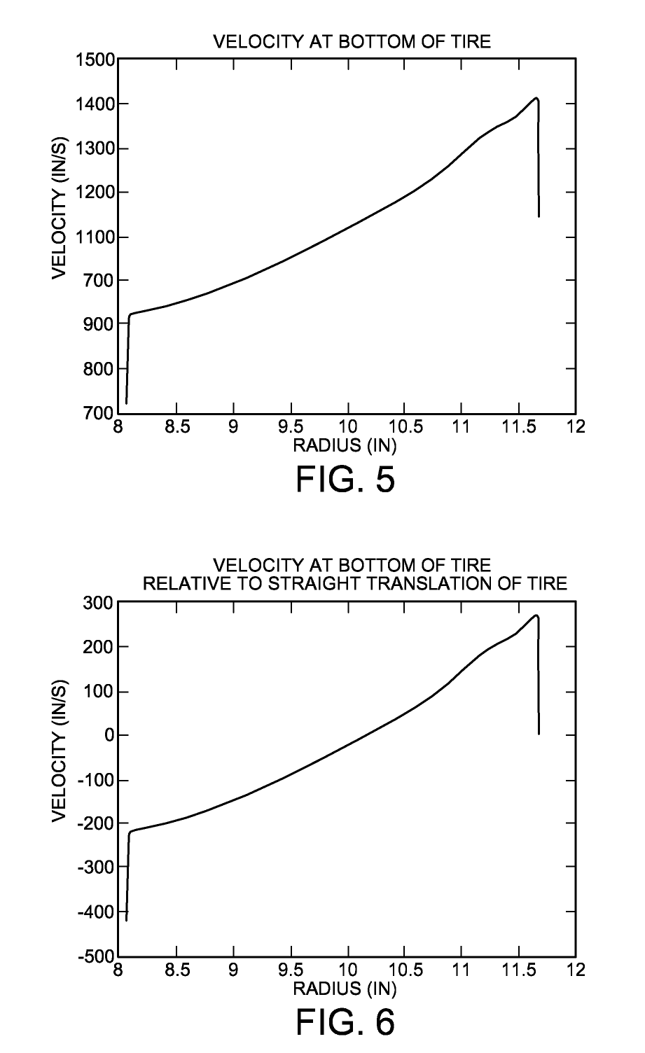

During operation, once per rotation any given section of the tire 420 will pass through the tire footprint 1110. As any given section of the tire 420 passes through the tire footprint 1110, the inflation air 431 contained in that section of the tire will also pass through the tire footprint 1110. A cross-section of the tire at or proximate to the tire footprint 1110 has a smaller area than a cross-section of the tire distal from the tire footprint. As a given section of the tire 420 passes through the tire footprint 1110 the cross-sectional area of that section is diminished, while the inflation air 431 contained in that section of the tire is passing therethrough. Because of the diminished area in the tire footprint 1110, the inflation air 431 contained in that section of the tire must flow more quickly relative to air flow 1160 elsewhere in internal cavity 430 in order to satisfy the relevant conservation requirements. This trend is generally borne out by the computational fluid dynamics results 110 shown in FIGS. 1-3. This trend is shown graphically in FIG. 5.

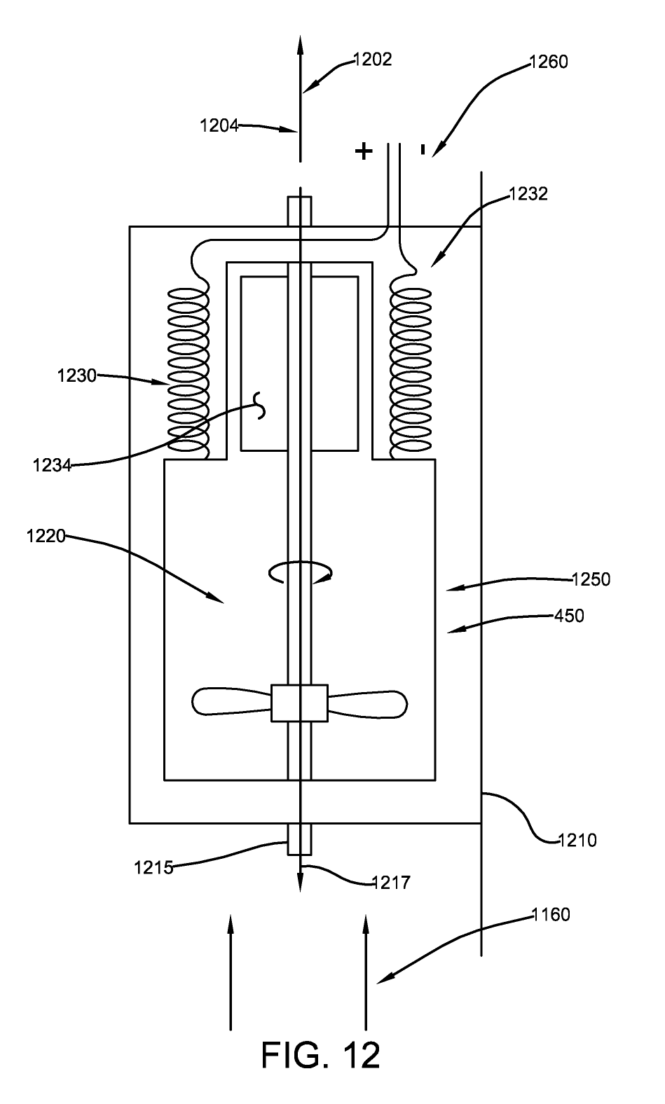

Referring now to FIGS. 12-18, a tire 420 or wheel 410 may comprise an air power feature 450. An air power feature 450 is adapted to accept an air flow 1160 and convert energy in said air flow 1160 to electrical energy. An air power feature may be adapted for engagement with a surface of a tire 420 or a wheel 410 that, if assembled into a tire-wheel system 400, would at least partially define an internal cavity 430. A surface of a tire 420 or a wheel 410 that, if assembled into a tire-wheel system 400, would at least partially define an internal cavity 430 may comprise annular interior surface 424, wheel rim surface 413, sidewall internal surface 425, or a sidewall internal surface 429 opposite second tire sidewall 428. An air power feature may be directly engaged with a surface of a tire 420 or a wheel 410, or indirectly engaged with the a surface of a tire 420 or a wheel 410. In some embodiments in which an air power feature is indirectly engaged with a surface of a tire 420 or a wheel 410 the air power feature is directly engaged with an intermediate component, such as, and without limitation, a valve stem (not shown), a tire pressure monitoring system (TPMS) (not shown), or an active noise interference device (not shown), that is engaged with a surface of a tire 420 or a wheel 410.

An air power feature 450 or a component of an air power feature, such as without limitation air power feature housing 1210, 1310, 1410, 1510, 1610, 1710 may be engaged with a surface of the tire 420 or a surface of the wheel 410 or to another component engaged with the tire 420 or the wheel 410, such as, and without limitation, a valve stem (not shown), a tire pressure monitoring system (TPMS) (not shown), or an active noise interference device (not shown), by an adhesive, a mechanical fastener, a molding operation, by being integrally formed with said tire 420 or said wheel 410, or by engagement to a component integrally formed with said tire 420 or said wheel 410. An adhesive may comprise polyvinyl acetate, polyurethane, polyethylene, epoxy, cyanoacrylate, or other adhesive chosen with good engineering judgment. A mechanical fastener may comprise a screw, a bolt, a nut, a clip, a clamp, a pin, a staple, a rivet, or other mechanical fastener chosen with good engineering judgment. A molding operation may comprise a tire molding operation, an injection molding operation, or other molding operation chosen with good engineering judgment. Components that are integrally formed are not formed as separate pieces, but rather are formed already joined as a single unitary piece. A non-limiting example of components that are integrally formed would be an embodiment in which a component of an air power feature 450, such as without limitation, an air power feature housing 1210, 1310, 1410, 1510, 1610, 1710 is molded together with a carcass component (not shown) by extruding an overly thick carcass component (not shown) and milling away surrounding material until the air power feature housing 1210 was left as an integrally formed component with the carcass component (not shown). In some embodiments, an air power feature housing 1210, 1310, 1410, 1510, 1610, 1710 may be an integrally formed component of a surface of a tire 420 or a wheel 410 that, if assembled into a tire-wheel system 400, would at least partially define an internal cavity 430.

In some embodiments a tire 420 or a wheel may comprise one or more air power features 450. In some embodiments a tire 420 may comprise a plurality of air power features 450 engaged with annular interior surface 424, wheel rim surface 413, sidewall internal surface 425, or a sidewall internal surface 429 opposite second tire sidewall 428.

Referring now to FIGS. 4 and 12-17, an air power feature 450 may take any of a variety of forms. In each of the non-limiting embodiments shown in FIGS. 12-17, the air power feature 450, 1250, 1350, 1450, 1550, 1650, 1750 comprises a housing 1210, 1310, 1410, 1510, 1610, 1710, a turbine element 1220, 1320, 1420, 1520, 1620, 1720 and a generator element 1230, 1330. In general, a housing 1210, 1310, 1410, 1510, 1610, 1710 may comprise any element adapted to hold other components of an air power feature 450, 1250, 1350, 1450, 1550, 1650, 1750 in a substantially fixed position with respect to one another. In general, a turbine element 1220, 1320, 1420, 1520, 1620, 1720 may comprise any element adapted to extract energy from air flow 1160 and convert it into shaft work. In general, a generator element 1230, 1330 may comprise any element adapted to convert shaft work into electrical energy. In each of the non-limiting embodiments shown in FIGS. 12-17, the air power feature 450, 1250, 1350, 1450, 1550, 1650, 1750 comprises a housing 1210, 1310, 1410, 1510, 1610, 1710, which holds a turbine element 1220, 1320, 1420, 1520, 1620, 1720 and a generator element 1230, 1330; the turbine element 1220, 1320, 1420, 1520, 1620, 1720 adapted to extract energy from air flow 1160 and convert it into shaft work; the generator 1230, 1330 being engaged, directly or indirectly with the turbine element 1220, 1320, 1420, 1520, 1620, 1720 to receive the shaft work therefrom and to convert the shaft work into electrical energy. In some embodiments, an air power feature may comprise other means for converting energy in an air flow 1160 to electrical energy.

As shown in FIG. 12, an air power feature 1250 may comprise a housing 1210 adapted to accept an air flow 1160; an elongated shaft 1215 rotatably engaged with the housing 1210 in such a manner that the axis of elongation 1217 of the shaft 1215 is substantially parallel to air flow 1160; a turbine element 1220 comprising an axial flow airfoil 1222 being engaged with shaft 1215 and adapted to impart shaft work to shaft 1215; a rotary generator 1230 comprising a stator 1232 engaged with the housing 1230 and a rotor 1234 engaged with shaft 1215 so as to be movable with respect to stator 1232, the rotor being adapted to receive shaft work from shaft 1215; and an electrical power output 1260 engaged with the rotary generator 1230 to receive electrical energy generated thereby and adapted to distribute the electrical energy. In an alternative embodiment, the apparatus shown in FIG. 12 may be positioned in such a manner that shaft 1215 is not substantially parallel to air flow 1160.

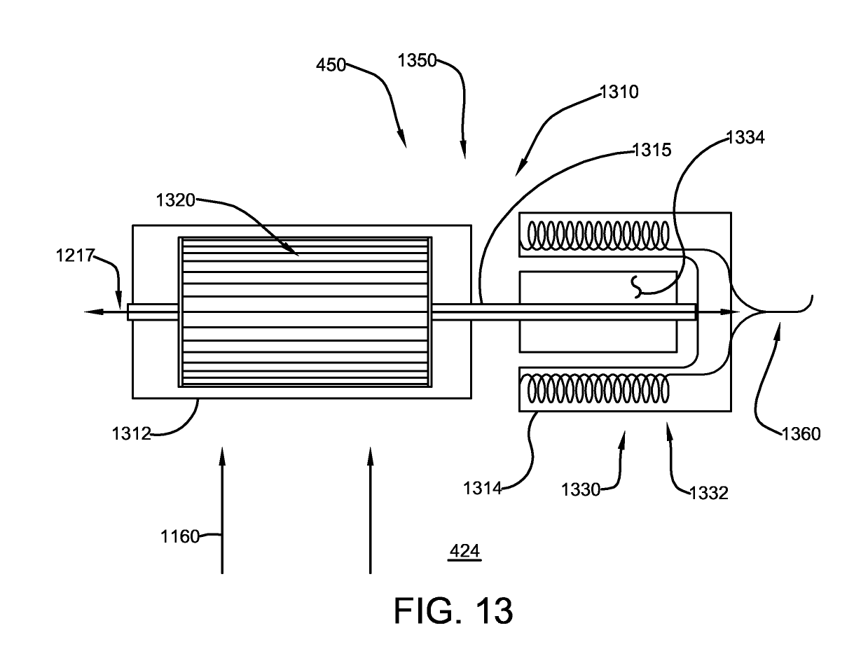

As shown in FIG. 13, an air power feature 1350 may comprise a housing comprised of a first housing component 1312 adapted to accept an air flow 1160 and a second housing component 1314 engaged with the first housing component 1312. In the embodiment shown in FIG. 13, the second housing component 1314 may be engaged with the first housing component 1312 through a platform, plate, foundation, or surface of a tire 420 or a wheel 410, such as, without limitation, annular interior surface 424, to which they are mutually engaged. An elongated shaft 1315 rotatably engaged with the housing 1310 in such a manner that the axis of elongation 1317 of the shaft 1315 is substantially perpendicular to air flow 1160; a turbine element 1320 comprising a crossflow flow airfoil 1322 being engaged with shaft 1315 and adapted to impart shaft work to shaft 1315; a rotary generator 1330 comprising a stator 1332 engaged with the housing 1310 and a rotor 1334 engaged with shaft 1315 so as to be movable with respect to stator 1332, the rotor being adapted to receive shaft work from shaft 1315; and an electrical power output 1360 engaged with the rotary generator 1330 to receive electrical energy generated thereby and adapted to distribute the electrical energy. In an alternative embodiment, the apparatus shown in FIG. 13 may be positioned in such a manner that shaft 1315 is not substantially perpendicular to air flow 1160.

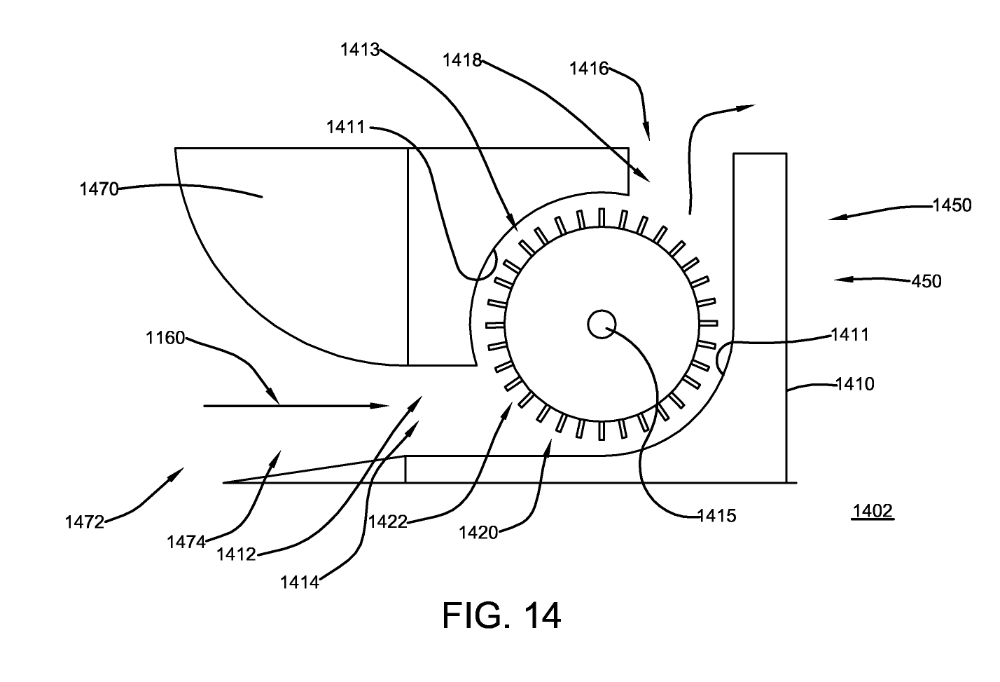

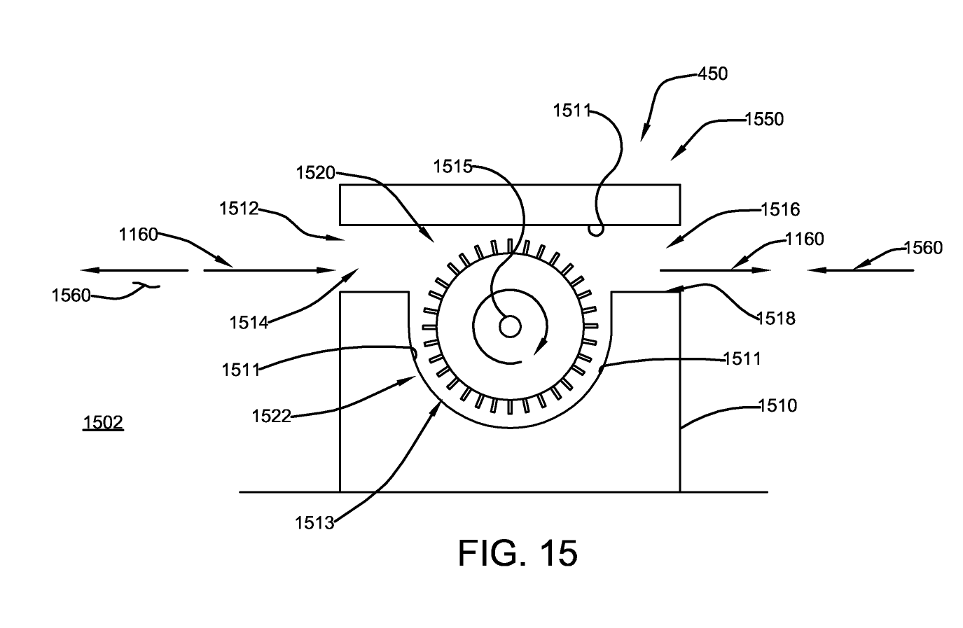

Referring now to FIGS. 14-17, shown are various embodiments of an air power features 1450, 1550, 1650, 1750 comprising a housing 1410, 1510, 1610, 1710 adapted to accept an air flow 1160; an elongated shaft 1415, 1515, 1615, 1715 rotatably engaged with the housing 1410, 1510, 1610, 1710; a turbine element 1420, 1520, 1620, 1720 comprising an cross flow airfoil 1422, 1522, 1622, 1722 being engaged with shaft 1415, 1515, 1615, 1715 and adapted to impart shaft work to shaft 1415, 1515, 1615, 1715; a rotary generator 1330 comprising a stator 1332 engaged with the housing 1410, 1510, 1610, 1710 and a rotor 1334 engaged with shaft 1415, 1515, 1615, 1715 so as to be movable with respect to stator 1332, the rotor being adapted to receive shaft work from shaft 1415, 1515, 1615, 1715; and an electrical power output 1360 engaged with the rotary generator 1330 to receive electrical energy generated thereby and adapted to distribute the electrical energy.

Referring now to FIG. 14, air power feature 1450 comprises a first duct 1470 in fluid engagement with an inlet 1412 of housing 1410; the inlet 1412 is in fluid engagement with a turbine enclosure region 1413 of housing 1410; the turbine enclosure region 1413 is in fluid engagement with an outlet 1416 of housing 1410. First duct 1470 comprises a first passage 1472 therethrough. The first passage 1472 may comprise a duct of constant cross-sectional area, a converging nozzle 1474, a diverging nozzle, a converging-diverging nozzle, a screen, a filter or other components adapted to modify air flow 1160 chosen consistent with good engineering judgment. Generally, an air flow modification component may comprise any of: a duct of constant cross-sectional area, a converging nozzle 1474, a diverging nozzle, a converging-diverging nozzle, a screen, a filter, other components adapted to modify air flow 1160 chosen consistent with good engineering judgment, or combinations thereof. In general, a converging nozzle, a diverging nozzle, or a converging-diverging nozzle may be adapted to modify the velocity of air flow 1160, the pressure of air flow 1160, or the mass flow rate of air flow 1160. In general, a screen, or a filter may be adapted to prevent the passage of dust or debris. Inlet 1412 is a port providing fluid communication for air flow 1160 into housing 1410 from the environment 1402 external to housing 1410 to the turbine enclosure region 1413 of housing 1410. Inlet 1412 may comprise a duct of constant cross-sectional area 1414, a converging nozzle, a diverging nozzle, a converging-diverging nozzle, a screen, a filter or other components adapted to modify air flow 1160 chosen consistent with good engineering judgment. The housing 1410 comprises airfoil containment surfaces 1411 which define the turbine enclosure region 1413. Airfoil containment surfaces 1411 closely conform to the region swept out by the cross flow airfoil 1422 of the turbine 1420 as it rotates during operation. Airfoil containment surfaces 1411 aid efficiency by preventing air from bypassing the turbine airfoil or otherwise flowing through the turbine without imparting substantial energy thereto. Outlet 1416 is a port providing fluid communication for air flow 1160 out of housing 1410 from the turbine enclosure region 1413 of housing 1410 to the environment 1402 external to housing 1410. Outlet 1416 may comprise a duct of constant cross-sectional area 1418, a diverging nozzle, a converging nozzle, a converging-diverging nozzle, a screen, a filter or other components adapted to modify air flow 1160 chosen consistent with good engineering judgment. During operation of air power feature 1450, air flow 1160 is inducted by first duct 1472 and passes through passage 1474 to the inlet 1412; passes through duct 1414 to the turbine enclosure region 1413 and over or through cross flow airfoil 1422 of the turbine 1420 imparting energy thereto; and exits air power feature 1450 through outlet 1416. As shown in FIG. 14, in some embodiments, an air power feature 1450 may have a directional bias such that it operates well with an air flow 1160 in a first direction, and not as well or not at all with air flow in a direction opposite the first direction 1160.

Referring now to FIG. 15, air power feature 1550 comprises an inlet 1512 of housing 1510; the inlet 1512 is in fluid engagement with a turbine enclosure region 1513 of housing 1510; the turbine enclosure region 1513 is in fluid engagement with an outlet 1516 of housing 1510. The air power feature 1550 may be adapted to function equally well or substantially equally well either with an air flow in the direction of air 1160 or with an air flow in the direction of air flow 1560. That is, the air power feature 1550 may operate as well or substantially as well with air flow 1160 entering inlet 1512, flowing across or through turbine 1520, and exiting outlet 1516, as with air flow 1560 entering outlet 1516, flowing across or through turbine 1520, and exiting inlet 1512. Accordingly, it is to be understood that the terms inlet 1512 and outlet 1516 are non-limiting and either may perform the functions of intaking or outputting an air flow. That is, and as will be described more fully herebelow, inlet 1512 may function to intake air flow 1160 or to output air flow 1560 and outlet 1516 may function to intake air flow 1560 or to output air flow 1160. Inlet 1512 is a port providing fluid communication between the environment 1502 and the turbine enclosure region 1513. Inlet 1512 may comprise a duct of constant cross-sectional area 1514, a converging nozzle, a diverging nozzle, a converging-diverging nozzle, a screen, a filter or other components adapted to modify air flow 1160 or air flow 1560 chosen consistent with good engineering judgment. The housing 1510 comprises airfoil containment surfaces 1511 which define the turbine enclosure region 1513. Airfoil containment surfaces 1511 closely conform to the region swept out by the cross flow airfoil 1522 of the turbine 1520 as it rotates during operation. Airfoil containment surfaces 1511 aid efficiency by preventing air from bypassing the turbine airfoil or otherwise flowing through the turbine without imparting substantial energy thereto. Outlet 1516 is a port providing fluid communication between the turbine enclosure region 1513 and the environment 1502. Outlet 1516 may comprise a duct of constant cross-sectional area 1518, a diverging nozzle, a converging nozzle, a converging-diverging nozzle, a screen, a filter or other components adapted to modify air flow 1160 or air flow 1560 chosen consistent with good engineering judgment. As noted above, in some embodiments an air power feature 1550 is adapted to function bi-directionally such that it functions equally well or substantially equally well with flow in a first direction 1160 as with air flow in a second direction 1560 opposite to the first direction 1160. In the bi-directionally functional embodiment shown in FIG. 15, turbine 1520 is adapted to function equally well or substantially equally well with air flow 1160 as with air flow 1560. During operation of air power feature 1550 in a first direction, air flow 1160 is inducted into the inlet 1512; passes through duct 1514 to the turbine enclosure region 1513 and over or through cross flow airfoil 1522 of the turbine 1520 imparting energy thereto; and exits air power features 1550 through outlet 1516. During operation of air power feature 1550 in a second direction, air flow 1560 is inducted into the outlet 1516; passes through duct 1518 to the turbine enclosure region 1513 and over or through cross flow airfoil 1522 of the turbine 1520 imparting energy thereto; and exits air power features 1550 through inlet 1512.

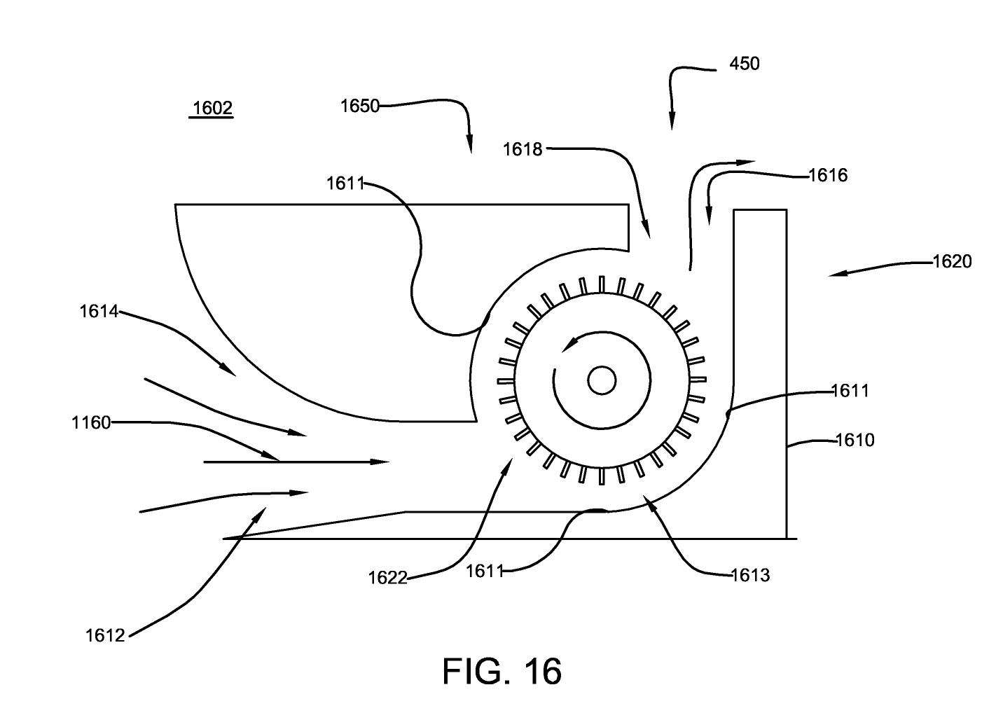

Referring now to FIG. 16, air power features 1650 comprises an inlet 1612 of housing 1610; the inlet 1612 is in fluid engagement with a turbine enclosure region 1613 of housing 1610; the turbine enclosure region 1613 is in fluid engagement with an outlet 1616 of housing 1610. Inlet 1612 is a port providing fluid communication for air flow 1160 into housing 1610 from the environment 1602 external to housing 1610 to the turbine enclosure region 1613 of housing 1610. Inlet 1612 may comprise an air flow modification component such as, without limitation, a duct of constant cross-sectional area, a converging nozzle 1614, a diverging nozzle, a converging-diverging nozzle, a screen, a filter or other components adapted to modify air flow 1160 chosen consistent with good engineering judgment. The housing 1610 comprises airfoil containment surfaces 1611 which define the turbine enclosure region 1613. Airfoil containment surfaces 1611 closely conform to the region swept out by the cross flow airfoil 1622 of the turbine 1620 as it rotates during operation. Airfoil containment surfaces 1611 aid efficiency by preventing air from bypassing the turbine airfoil or otherwise flowing through the turbine without imparting substantial energy thereto. Outlet 1616 is a port providing fluid communication for air flow 1160 out of housing 1610 from the turbine enclosure region 1613 of housing 1610 to the environment 1602 external to housing 1610. Outlet 1516 may comprise an air flow modification component such as, without limitation, a duct of constant cross-sectional area 1618, a diverging nozzle, a converging nozzle, a converging-diverging nozzle, a screen, a filter or other components adapted to modify air flow 1160 chosen consistent with good engineering judgment. During operation of air power feature 1650, air flow 1160 is inducted by the inlet 1612; passes through duct 1614 to the turbine enclosure region 1613 and over or through cross flow airfoil 1622 of the turbine 1620 imparting energy thereto; and exits air power features 1650 through outlet 1616. As shown in FIG. 16, in some embodiments, an air power features 1650 may have a directional bias such that it operates well with an air flow 1160 in a first direction, and not as well or not at all with air flow in a direction opposite the first direction 1160.

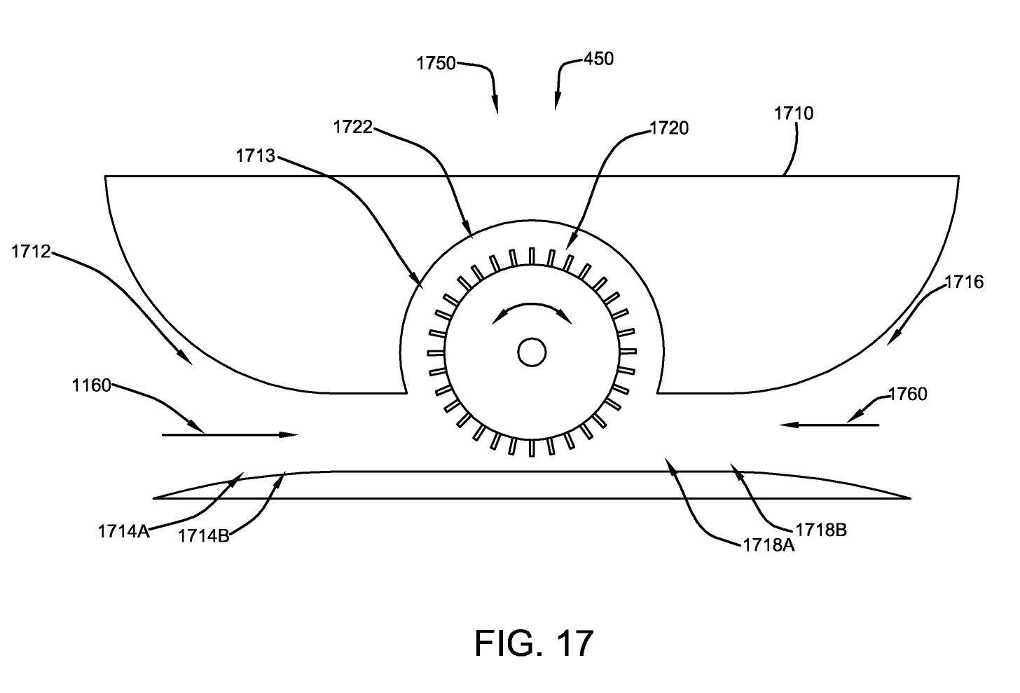

Referring now to FIG. 17, air power features 1750 comprises an inlet 1712 of housing 1710; the inlet 1712 is in fluid engagement with a turbine enclosure region 1713 of housing 1710; the turbine enclosure region 1713 is in fluid engagement with an outlet 1716 of housing 1710. The air power feature 1750 may be adapted to function equally well, or substantially equally well, either with an air flow in the direction of air 1160 or with an air flow in the direction of air flow 1760. That is, the air power feature 1750 may operate as well or substantially as well with air flow 1160 entering inlet 1712, flowing across or through turbine 1720, and exiting outlet 1716, as with air flow 1760 entering outlet 1716, flowing across or through turbine 1720, and exiting inlet 1712. Accordingly, the terms inlet 1712 and outlet 1716 are non-limiting and either may perform the functions of intaking or outputting an air flow. That is, and as will be described more fully herebelow, inlet 1712 may function to intake air flow 1160 or to output air flow 1760 and outlet 1716 may function to intake air flow 1760 or to output air flow 1160. Inlet 1712 is a port providing fluid communication between the environment 1702 and the turbine enclosure region 1713. Inlet 1712 may comprise an air flow modification component such as, without limitation, a duct of constant cross-sectional area, a converging nozzle 1714a, a diverging nozzle 1714b, a converging-diverging nozzle, a screen, a filter or other components adapted to modify air flow 1160 or air flow 1560 chosen consistent with good engineering judgment. It is to be understood that a converging nozzle is a nozzle in which the cross-sectional area of the nozzle decreases in the direction of flow and that a diverging nozzle is one in which the cross-sectional area of the nozzle increases in the direction of flow. With these definitions of converging nozzle and diverging nozzle in mind, it should be made explicit that the converging nozzle 1714a, and the diverging nozzle 1714b may be the same structure distinguished by the direction of flow therethrough; when the flow through 1712 is air flow 1160 the passage in inlet 1712 may be referred to as converging nozzle 1714a and when the flow through 1712 is air flow 1760 the passage in inlet 1712 may be referred to as diverging nozzle 1714b. The housing 1710 comprises airfoil containment surfaces 1711 which define the turbine enclosure region 1713. Airfoil containment surfaces 1711 closely conform to the region swept out by the cross flow airfoil 1722 of the turbine 1720 as it rotates during operation. Airfoil containment surfaces 1711 aid efficiency by preventing air from bypassing the turbine airfoil or otherwise flowing through the turbine without imparting substantial energy thereto. Outlet 1716 is a port providing fluid communication between the turbine enclosure region 1713 and the environment 1702. Outlet 1716 may comprise an air flow modification component such as, without limitation, a duct of constant cross-sectional area, a diverging nozzle 1718a, a converging nozzle 1718b, a converging-diverging nozzle, a screen, a filter or other components adapted to modify air flow 1160 or air flow 1760 chosen consistent with good engineering judgment. Similar to the situation noted above with respect to converging nozzle 1714a and diverging nozzle 1714b, the diverging nozzle 1714a and the converging nozzle 1718b may be the same structure distinguished by the direction of flow therethrough; when the flow through 1716 is air flow 1160 the passage in outlet 1716 may be referred to as diverging nozzle 1718a and when the flow through outlet 1716 is air flow 1760 the passage in outlet 1716 may be referred to as converging nozzle 1718b. As noted above, in some embodiments an air power feature 1750 is adapted to function bi-directionally such that it functions equally well, or substantially equally well, with flow in a first direction 1160 as with air flow in a second direction 1760 opposite to the first direction 1160. In the bi-directionally functional embodiment shown in FIG. 17, turbine 1720 is adapted to function equally well or substantially equally well with air flow 1160 as with air flow 1760. During operation of air power feature 1750 in a first direction, air flow 1160 is inducted into the inlet 1712; passes through converging nozzle 1714a to the turbine enclosure region 1713 and over or through cross flow airfoil 1722 of the turbine 1720 imparting energy thereto; and exits air power features 1750 through outlet 1716 passing through diverging nozzle 1718a. During operation of air power feature 1750 in a second direction, air flow 1760 is inducted into the outlet 1716; passes through converging nozzle 1718b to the turbine enclosure region 1713 and over or through cross flow airfoil 1722 of the turbine 1720 imparting energy thereto; and exits air power features 1750 through inlet 1712 passing through diverging nozzle 1714b.

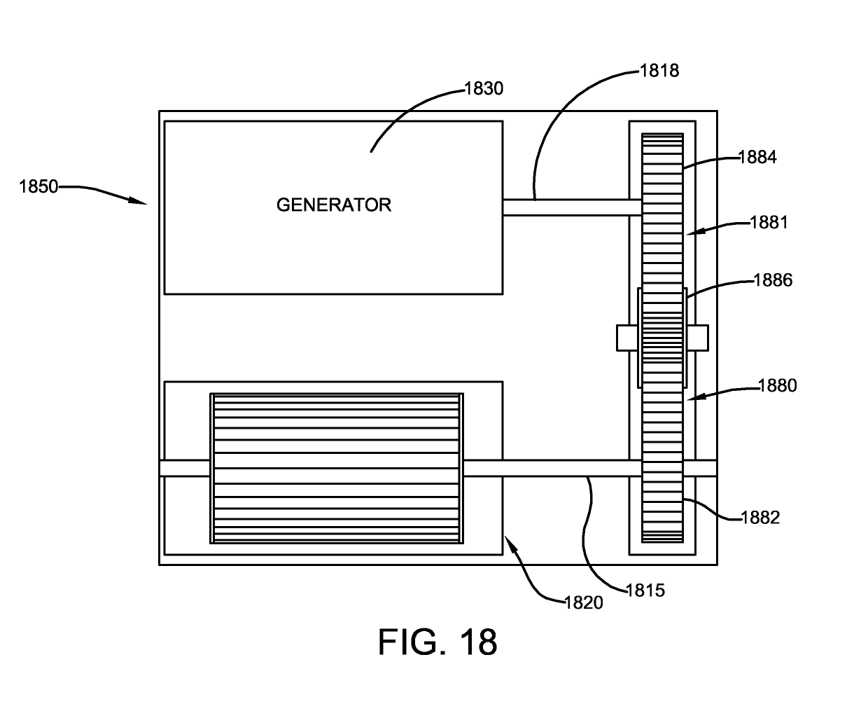

Referring now to FIG. 18, shown is one embodiment of an air power feature 1850. In the embodiment shown in FIG. 18, the generator 1830 is engaged with the turbine element 1820 through a transmission 1880. The transmission 1880 is adapted to transmit shaft work from the turbine element 1820 to the generator 1830. The transmission 1880 may also be adapted to provide some mechanical advantage, modify the transmitted shaft work to increase velocity, decrease velocity, change direction of rotation, increase torque, decrease torque, or otherwise change properties of the transmitted shaft work. Transmission 1880 may take a variety of embodiments, including but not limited to embodiments comprising a gear train, an epicyclic gearing, a worm drive, a belt and pulley system, a chain drive, a mechanical linkage, another mechanism, or other means for transmitting shaft work from the turbine element 1820 to the generator 1830. In the non-limiting embodiment shown in FIG. 18, the turbine element 1820 is engaged to generator 1830 by a transmission 1880 embodied by a gear train 1881. In FIG. 18, turbine element 1820 is adapted to extract energy from an air flow 1160 and convert it into shaft work which is transmitted through shaft 1815. The shaft 1815 is operationally engaged with, and is adapted to deliver the shaft work to, an input gear 1882 of gear train 1881. Input gear 1882 is operationally engaged with the shaft 1815 to receive shaft work therefrom, and is operationally engaged with an output gear 1884 to transmit shaft work thereto. Generally, the operational engagement between an input gear 1882 and an output gear 1884 may be direct engagement or indirect engagement. In direct engagement, the input gear 1882 and the output gear 1884 mesh with one another directly. In indirect engagement the engagement is made through an intermediate component. In the embodiment shown in FIG. 18, the operational engagement between the input gear 1882 and the output gear 1884 is indirect engagement wherein engagement is made through an idler gear 1886. Output gear 1884 is operationally engaged with shaft 1818 and is adapted to deliver shaft work thereto. Generator 1830 is adapted to accept shaft work from shaft 1818 and to convert the shaft work into electrical energy.

As noted above, a turbine element 1220, 1320, 1420, 1520, 1620, 1720 may comprise an axial flow airfoil 1222, or a crossflow flow airfoil 1322. In other embodiments, a turbine element 1220, 1320, 1420, 1520, 1620, 1720 may comprise one or more other types of airfoils, such as without limitation, a helical airfoil, chosen consistent with good engineering judgment.

In certain embodiments, an air power feature 450 may comprise components other than a turbine element 220, 1320, 1420, 1520, 1620, 1720 and/or a generator element 1230, 1330. In certain embodiments, an air power feature 450 may comprise a piezoelectrical air power feature. A piezoelectrical air power feature is an air power feature 450 comprising a piezoelectrical component adapted to extract energy from air flow 1160 and convert it into electrical energy. In certain embodiments, and without limitation, a piezoelectrical air power feature may be engaged with an air flow modification component to receive an air flow therefrom.

A piezoelectrical air power feature may be as described in U.S. Pat. No. 4,387,318, filed on Jun. 4, 1981 which is herein incorporated by reference in its entirety. A piezoelectrical air power feature may comprise a flutter vane type of piezoelectric fluid-electric generator as disclosed in U.S. Pat. No. 4,387,318. A piezoelectrical air power feature may comprise a reed-type piezoelectric fluid-electric generator as disclosed in U.S. Pat. No. 4,387,318. As noted in U.S. Pat. No. 4,387,318, a flutter vane type of piezoelectric fluid-electric generator may be tuned to respond optimally to a particular air flow velocity. Since the air flow velocity at a particular location within an internal cavity 430 of a tire-wheel system 400 may be predicted based upon operational conditions, an air power feature 450 may be tuned to respond optimally to a predicted air flow velocity in the position where the air power feature 450 is mounted. For example, and without limitation, an air power feature 450 may be adapted for placement on the annular interior surface 424 of a tire 420 and the air power feature 450 may be tuned for the air flow velocity predicted to occur at the annular interior surface 424 of a tire distal from the footprint during some nominal speeds under some nominal loading condition. Furthermore, as described more fully herebelow, a piezoelectrical air power feature may be engaged with an air flow modification component adapted to modify air flow 1160 properties or to induct air from one or more regions of an internal cavity 430 so as to produce an air flow 1160 having particular properties.

A piezoelectrical air power feature may comprise components as described in U.S. Pat. No. 7,772,712, filed on Sep. 4, 2007 which is herein incorporated by reference in its entirety. In certain embodiments, a piezoelectrical air power feature may comprise a fluid-induced energy converter with curved parts as described in U.S. Pat. No. 7,772,712. In certain embodiments, a piezoelectrical air power feature may comprise a surface adapted to undergo aeroelastic flutter in response to the flow of a fluid thereover.

A piezoelectrical air power feature may be as described in U.S. Pat. No. 8,102,072 filed on Dec. 31, 2008 which is herein incorporated by reference in its entirety. In certain embodiments, a piezoelectrical air power feature may comprise an aerodynamic vibration power-generation device as described in U.S. Pat. No. 8,102,072.

A piezoelectrical air power feature may be as described in U.S. patent application Ser. No. 13/115,547 filed on Dec. 1, 2011 which is herein incorporated by reference in its entirety. In certain embodiments, a piezoelectrical air power feature may comprise a fluid current energy capture apparatus as described in U.S. patent application Ser. No. 13/115,547.

In general, a piezoelectrical air power feature may be engaged with an air flow modification component adapted to modify air flow 1160 properties or to induct air from one or more regions of an internal cavity 430. As noted above, an air flow modification component may modify air flow 1160 properties or to induct air from one or more regions of an internal cavity 430. An air flow modification component may comprise a converging nozzle, a diverging nozzle, or a converging-diverging nozzle, a screen, or a filter. A nozzle may be adapted to modify the velocity of air flow 1160, the pressure of air flow 1160, the mass flow rate of air flow 1160, or to combine air from one or more regions of an internal cavity 430. Generally, a piezoelectrical air power feature may be engaged with a duct of constant cross-sectional area, a diverging nozzle, a converging nozzle, a converging-diverging nozzle, a screen, a filter or other components adapted to modify air flow 1160 chosen consistent with good engineering judgment. As with a generator 1230, 1330, piezoelectrical air power feature may produce electrical energy and may be engaged with an electrical power output 1260 engaged with the piezoelectrical air power feature to receive electrical energy produced thereby and adapted to distribute the electrical energy.

As noted above, an air power feature 450 may deliver electricity produced thereby to an electrical power output 1260 adapted to distribute the electrical energy. The electrical power output 1260 may distribute the electrical energy to any of a number of devices adapted to receive electrical energy. The electrical power output 1260 may distribute the electrical energy to an electrical energy conditioning device (not shown), to a rectifier, to an inverter, to a battery (not shown), a capacitor, or other energy storage device, to a tire pressure monitoring system (not shown), to an active noise interference device (not shown) or to another device that uses electricity. An electrical energy conditioning device, also known as a power conditioner, a line conditioner, or a power line conditioner may be any device adapted to condition electrical energy. Without limitation, an electrical energy conditioning device may work to maintain a constant AC frequency or to maintain a constant voltage.

Referring now to FIGS. 5-10 shown are a series of graphs describing calculated air flow velocity inside a tire-wheel system as a function of variables comprising radial position using assumptions identical to those used in calculating the computational fluid dynamics results 110 shown in FIGS. 1-3. Graph 5 shows air flow velocity near the footprint as a function of radial position. Graph 6 shows air flow velocity near the footprint relative to straight translation with the tire as a function of radial position in a tire-wheel system with an air power feature 450 mounted to an annular interior tire surface 424 proximate to the tire crown. Graph 7 shows air flow velocity near the footprint relative to rigid rotation with the wheel as a function of radial position in a tire-wheel system with an air power feature 450 mounted to an annular exterior surface, such as wheel rim surface 413. Graph 8 shows air flow velocity near the top of the tire as a function of radial position in a tire-wheel system. As noted above, the computational fluid dynamics results 110 project that the flow along inner radius 13 is approximately 715 inches per second while the flow along outer radius 137 is approximately 1142 inches per second. Accordingly, the results in FIG. 8 show that in regions distal from the footprint, the air velocity is slightly less than the neighboring mass. Graph 9 shows air flow velocity near the tire crown relative to rigid rotation with the tire as a function of radial position in a tire-wheel system with an air power feature 450 mounted to an annular interior tire surface 424 proximate to the tire crown. Graph 10 shows air flow velocity near the tire crown relative to rigid rotation with the wheel as a function of radial position in a tire-wheel system with an air power feature 450 mounted to an annular exterior surface, such as wheel rim surface 413.

While the air power feature has been described above in connection with certain embodiments, it is to be understood that other embodiments may be used or modifications and additions may be made to the described embodiments for performing the same function of the air power feature without deviating therefrom. Further, the air power feature may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the air power feature. Therefore, the air power feature should not be limited to any single embodiment, but rather construed in breadth and scope in accordance with the recitation of the attached claims.

What is claimed is:

1-15. (canceled)

16. An apparatus comprising,
an air power feature that converts energy in an air flow to electrical energy;
wherein said air power feature comprises:
a turbine and a generator; or,
a piezoelectrical component; and,
wherein said air power feature is:
engaged with a tire; or,
engaged with a wheel.

17. The apparatus of claim 16, wherein:
said air power feature is engaged to said tire by an adhesive, or by a mechanical fastener, or by a molding operation, or by a component integrally formed therewith; or
said air power feature is engaged to said wheel by an adhesive, or by a mechanical fastener, or by a molding operation, or by a component integrally formed therewith.

18. The apparatus of claim 16, wherein said air power feature is engaged with an air flow modification component comprising:
a duct of constant cross-sectional area, or
a converging nozzle, or
a diverging nozzle, or
a converging-diverging nozzle, or
a screen, or
a filter, or
some combination thereof.

19. The apparatus of claim 16, wherein:
a tire comprises:
a tread surface;
a first sidewall surface;
an annular interior surface opposite said tread surface; and
a first sidewall internal surface opposite said first sidewall surface; and,
said air power feature is engaged with:
said annular interior surface; or,
said first sidewall internal surface; or,
a combination thereof.

20. The apparatus of claim 19, wherein said tire is a pneumatic tire.

21. The apparatus of claim 16, wherein said air power feature converts energy in tire inflation air flow to electrical energy.

22. The apparatus of claim 16, wherein said air power feature comprises a turbine and a generator.

23. The apparatus of claim 18, wherein said air power feature comprises,
a housing engaged with a tire, said housing comprising:
an inlet engaged with said air flow modification component and adapted to receive an air flow therefrom,
an outlet for said air flow, and
an airfoil containment surface;
a turbine engaged with said housing, said turbine comprising
an axial flow airfoil, a crossflow flow airfoil, or a helical airfoil,
said turbine being adapted to extract energy from said air flow and convert said energy into first shaft work;
a transmission engaged with said turbine to receive said first shaft work therefrom, said transmission comprising,
a gear train,
an epicyclic gearing,
a worm drive,
a belt and pulley system,
a chain drive, or
a mechanical linkage; and,
a generator engaged with said transmission, said generator adapted to accept second shaft work from said transmission and to convert said second shaft work into electrical energy.

24. The apparatus of claim 16, wherein said air power feature comprises a piezoelectrical component.

25. The apparatus of claim 24, wherein said air power feature comprises
a flutter vane type of piezoelectric fluid-electric generator; or
a reed-type piezoelectric fluid-electric generator; or
a fluid-induced energy converter with curved parts; or
an aerodynamic vibration power-generation device; or
a fluid current energy capture apparatus.

26. A tire-wheel system comprising
a wheel;
a tire mounted to said wheel; and
an air power feature that converts energy in an air flow to electrical energy; wherein said air power feature comprises:
a turbine and a generator; or,
a piezoelectrical component; and,
wherein said air power feature is:
engaged with the wheel; or,
engaged with the tire.

27. The tire-wheel system of claim 26, wherein
said tire comprises
a tread surface,
a first sidewall surface,
an annular interior surface opposite said tread surface, and
a first sidewall internal surface opposite said first sidewall surface; and
said air power feature is engaged with:
said annular interior surface; or,
said first sidewall internal surface; or,
a combination thereof.

28. The tire-wheel system of claim 26, wherein:
said wheel defines a rim surface; and,
said air power feature is engaged with said rim surface.

29. The tire-wheel system of claim 26, wherein:
said wheel and said tire define an internal cavity that receives inflation air for the tire; and,
said air power feature converts energy in a flow of said inflation air to electrical energy.

30. The tire-wheel system of claim 26, wherein said air power feature is engaged:
by an adhesive, or
by a mechanical fastener, or
by a molding operation, or
by a component integrally formed therewith.

31. The tire-wheel system of claim 26, wherein said air power feature is engaged with an air flow modification component comprising:
a duct of constant cross-sectional area, or
a converging nozzle, or
a diverging nozzle, or
a converging-diverging nozzle, or
a screen, or
a filter, or
some combination thereof.

32. The tire-wheel system of claim 26, wherein said air power feature comprises a turbine and a generator.

33. The tire-wheel system of claim 32, wherein:
said air power feature comprises, a housing that:
holds the turbine and the generator; and,
is engaged with the wheel; or, with the tire;
said housing comprising
an inlet engaged with said air flow modification component and adapted to receive an air flow therefrom,
an outlet for said air flow, and
an airfoil containment surface;
said turbine comprising
an axial flow airfoil,
a crossflow flow airfoil, or
a helical airfoil,
said turbine being adapted to extract energy from said air flow and convert it into first shaft work;
a transmission engaged with said turbine to receive said first shaft work therefrom, said transmission comprising,
a gear train,
an epicyclic gearing,
a worm drive,
a belt and pulley system,
a chain drive, or
a mechanical linkage; and,
a generator engaged with said transmission, said generator adapted to accept second shaft work from said transmission and to convert said second shaft work into electrical energy.

34. The tire-wheel system of claim 26, wherein said air power feature comprises a piezoelectrical component.

35. A pneumatic tire comprising
a tread surface;
a first sidewall surface;
an annular interior surface opposite said tread surface;
a first sidewall internal surface opposite said first sidewall surface; and
an air power feature that
converts energy in an air flow to electrical energy
is engaged with said annular interior surface or said first sidewall internal surface
by an adhesive, or
by a mechanical fastener, or
by a molding operation, or
by a component integrally formed therewith,
is engaged with an air flow modification component comprising
a duct of constant cross-sectional area, or
a converging nozzle, or
a diverging nozzle, or
a converging-diverging nozzle, or
a screen, or
a filter, or
some combination thereof, and
wherein said air power feature comprises either
a turbine, and a generator, or
a piezoelectrical component.
